(19) United States
(12) Patent Application Publication
(10) Pub. No.: US 2007/0250536 A1
(43) Pub. Date: Oct. 25, 2007

(54) Content Start Control Device

(76) Inventors: Akihiro Tanaka, Osaka (JP); Hideaki Nakaoka, Osaka (JP); Hideki Kagemoto, Nara (JP); Toru Kawaguchi, Tokyo (JP); Yasuyuki Sonoda, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/660,979

(22) PCT Filed: Aug. 24, 2005
(86) PCT No.: PCT/JP05/15369

§ 371 Date: Feb. 23, 2007

(30) Foreign Application Priority Data
Aug. 26, 2004 (JP) 2004-246159

(51) Int. Cl. G06F 15/00

(52) U.S. Cl. 707/104.1

(57) ABSTRACT

A content start control device that changes the resource to be started first within a content in accordance with the type of license purchased, and enables a plurality of viewing modes for one content is provided.

The content start instruction reception unit 201 of the content start control device 100 receives a start instruction for a content, and sends the content ID of the content to the license information verification unit 211. The license information verification unit 211 obtains information on whether or not a license has been purchased, by using license information obtained from the license information storage unit 221 and the content ID obtained from the content start instruction reception unit 201. The start resource selection unit 212 selects the start resource of the content which is associated with the license, by using start resource information, and the resource starting unit 213 starts the resource selected by the start resource selection unit 212.

### TECHNICAL FIELD

The present invention relates to a content start control device that manages a license and controls, at the time of reproduction, the starting of a content distributed through digital broadcast, the Internet and so on, and particularly to a content start control device that performs reproduction control in accordance with the type of a license.

### BACKGROUND ART

In recent years, with the development of networks such as those for broadcasting, communication and the like, terminals which obtain contents such as video, music, and games via these networks have appeared. For example, in Broadcast Satellite (BS) digital broadcasting and Communication Satellite (CS) digital broadcasting, video and audio are digitalized and distributed in accordance with the MPEG-2 standard and, even in terrestrial digital broadcasting, AV data including video and audio is also distributed in accordance with the same standard.

In addition, in the distribution through such broadcasting and communication networks and the like, there is a need to prevent unauthorized use of obtained contents in order to protect content copyrights and, conventionally, a method of limiting the use of a content by a user, by using a license which is data combining a key that can decrypt a content and a use condition for the content, is utilized.

Furthermore, for example, there is disclosed a method in which sample data of a content, billing information, a unique ID for identifying the content, and a location ID identifying the location of the body of the content in the network are included in the content, and the content is obtained, and after billing processing, billing is performed in accordance with size/resolution, output method, and so on, when downloading or reproducing the body of the content (see Patent Reference 1, for example).

FIG. 17 is a descriptive diagram of the reproduction of a content 1701 in the conventional technology. The content 1701 shown in FIG. 17 is configured of three resources, and Digital Rights Management (DRM) information such as an ID of a license necessary for the reproduction of each resource is described in the header of each of the resources. For each resource, it is possible to obtain/verify the license by using the DRM information described in the header.

Here, a resource refers to the smallest unit of data of video/audio in the MPEG-2 standard, images in the JPEG standard, and Broadcast Markup Language (BML) and so on, that can be reproduced in the device or in other devices. A content may be configured of one resource, and may also be configured of plural resources.

FIG. 18 is a descriptive diagram of the reproduction of a content 1801 in the conventional technology. The content 1801 shown in FIG. 18 is configured of one start resource information and three resources. DRM information such as an ID of a license necessary for the reproduction of each resource is described in the start resource information, and it is possible for all the resources in the content 1801 to obtain/verify the license by using the DRM information recorded in the start resource information.
Patent Reference 1: International Publication No: WO 2002/056220

### DISCLOSURE OF INVENTION

Problems that Invention is to Solve

However, the method shown in Patent Reference 1 does not disclose a reproduction method for the case where a content is configured of plural resources that can be reproduced.

Furthermore, in the case of reproducing the content 1701 shown in FIG. 17 in a reproduction apparatus, there is a problem in that the processing load for the reproduction apparatus is high when reproducing a content having multiple resources because it is necessary to perform processing such as reading the DRM information described in the header and obtaining the license, for each one of the resources that is started.

Furthermore, in the case of reproducing the content 1801 shown in FIG. 18 in a reproduction apparatus, the problem arising in the reproduction of the content 1701 shown in FIG. 17 does not exist because it is possible to obtain the license by using the DRM information described in the start resource information, and start the other resources within the content by using the license. However, since the start resource information is fixed, there is a problem that the resource which is started first within the content (resource 2 in FIG. 18) cannot be changed in accordance with the viewing mode of the user.

In addition, in order to solve the aforementioned problems, it is possible to utilize a structure in which a plurality of contents share a resource.

FIG. 19 is a descriptive diagram of the reproduction of a content 1901 in the case where a plurality of contents share a resource. In the diagram, a resource is shared by the content 1901 and a content 1902, and the content 1902 holds the material substance of a resource 1, a resource 2, and a resource 3. Only start resource information is described in the content 1901, and such start resource information refers to the resource 1 of the content 1902. In the case of a plurality of contents having such a structure, it becomes possible to carry out reproduction in the preferred viewing mode, through the user's selection of the content to be reproduced (the content 1901 and 1902 in FIG. 19).

However, since in this method, resource referencing relationships exist, not only within a content, but also between different contents, it is not possible to guarantee at all times that the reference destination content referred to by the start resource information is a correct resource in terms of the configuration of the reference source content and, in particular, it is not suitable as a content format for providing contents through the paid distribution of licenses.

The present invention is conceived to solve all the aforementioned problems and has as an object to provide a content start control device capable of changing the start resource that is started first within a content, and providing, for one content, a plurality of viewing modes in accordance to the type of the license that is purchased.

Furthermore, another object is to provide a content start control device that enables the easy addition of a new viewing mode.

Still another object is to provide a content start control device that does not require a content to be stored again even when a content viewing mode is added.

Means to Solve the Problem

In order to solve the aforementioned conventional problem, the content start control device according to the present invention is a content start control device that controls a starting of a content, the content start control device including: a content start instruction reception unit which receives a start instruction for a content; a license information storage unit which stores license information of the content; a license information verification unit which obtains, based on the license information, a purchased license from among plural licenses which are associated with the content, in the case where the start instruction is received by the content start instruction reception unit; a start resource information storage unit which stores start resource information indicating start resources, each of which is associated with one of the licenses; a start resource selection unit which selects, based on the start resource information, a start resource that is associated with the license which is verified by the license information verification unit as having been purchased; and a resource starting unit which starts the start resource selected by the start resource selection unit.

According to the present configuration, since the license information verification unit obtains a purchased license and the start resource selection unit selects the start resource associated with this license, it becomes possible for the resource starting unit to select the start resource of the content associated with the purchased license from the plural resources making up a content, and start the selected start resource.

Furthermore, in the content start control device according to the present invention, the license information includes a relationship among a content ID, plural license IDs used for a content which corresponds to the content ID, and purchase/non-purchase information of each of the license IDs. The start resource information includes a relationship among the content ID, the plural license IDs used for the content which corresponds to the content ID, and respective start resources for the license IDs. The license information verification unit is obtains, based on the license information, a license ID of the purchased license, from among plural license IDs which are associated with a content ID of the content for which the start instruction is received, and the start resource selection unit selects a start resource which is associated with the license ID, based on the start resource information.

According to this configuration, plural license IDs of different types, which are associated with one content ID are set, and the resource of a content to be started is set for each of the license IDs by using the start resource information. Therefore, by using the content start control device according to the present invention, it becomes possible to provide various viewing modes based on one content, in accordance with the license-purchase status of the user.

Furthermore, in the content start control device according to the present invention, the content start instruction reception unit receives a start instruction for a content, from a second device. The license information verification unit obtains, by using the license information, purchase/non-purchase information of a license that is associated with the content for which the start instruction from the second device is received. The start resource selection unit is operable to select, by using the start resource information, a start resource which is associated with the license in the case where the license information verification unit verifies that the license is purchased, and the resource starting unit is operable to transmit, to the second device, at least the start resource selected by the start resource selection unit.

According to this configuration, in the case where the second device is a home server and the content start control device is a television, a content stored in the home server can be transmitted to the television as resource information, in accordance with the license-purchase status of the user, by specifying the content ID at the television side.

Note that, in order to achieve the aforementioned objects, the present invention may also be implemented as a content start control method having the characteristic constituent units of the content start control device as steps, and a program which includes all such steps. Furthermore, such program may also be distributed via a recording medium such as a CD-ROM and a communication network, aside from being stored in a ROM, or the like, included in the content start control apparatus.

Effects of the Invention

The content start control device according to the present invention can more easily provide a user with a plurality of viewing modes for the same content. Furthermore, content storage volume can be reduced in comparison to when one content is required for one license. In addition, it becomes possible to have a service that can easily upgrade a license to allow a plurality of viewing modes for the same content, through the user's payment of the price difference between licenses to the content provider.

### BRIEF DESCRIPTION OF DRAWINGS

FIG. 1 is a function block diagram of the content start control device in the first embodiment.

FIG. 2 is a reference diagram showing an example of a table in which license information stored in the license information storage unit is described.

FIG. 3 is a reference diagram showing an example of a table in which start resource information stored in the start resource information storage unit is described.

FIG. 4 is a reference diagram showing an example of a table in which license information stored in the license information storage unit is described.

FIG. 5 is a reference diagram showing an example of a table in which start resource information stored in the start resource information storage unit is described.

FIG. 6 is a flowchart showing the operational sequence from the start to the end of the content starting process in the content start control device 100 in FIG. 1.

FIG. 7 is a reference diagram of a display screen for prompting the purchase of a license to a user.

FIG. 8 is a reference diagram of a content reproduced in the content start control device according to the first embodiment.

FIG. 9 is a reference diagram showing an example of data description of start resource information which is referred to during a content start instruction by the content start control device according to the first embodiment.

FIG. 10 is a reference diagram showing an example of the transition of screen displays in the content start control device according to the first embodiment.

FIG. 11 is a reference diagram showing an example of the connection between the content start control device in the present invention and other devices.

FIG. 12 is a reference diagram showing an example of the connection between the content start control device in the present invention and other devices.

FIG. 13 is a reference diagram showing an example of a hardware configuration for implementing the content start control device of the present invention.

FIG. 14 is a function block diagram for the content start control device according to the second embodiment.

FIG. 15 is a reference diagram showing an example of a content reproduced with the content start control device according to the second embodiment.

FIG. 16 is a reference diagram for the case where the content start control device of the present invention is implemented by using an LSI.

FIG. 17 is a descriptive diagram of the reproduction of a content in the conventional technology.

FIG. 18 is a descriptive diagram of the reproduction of a content in the conventional technology.

FIG. 19 is a descriptive diagram of the reproduction of a content in the case where a plurality of contents share a resource.

### NUMERICAL REFERENCES

100, 1400, 1600 Content start control device
201 Content start instruction reception unit
211 License information verification unit
211 Start resource selection unit
213 Resource starting unit
221 License information storage unit
222 Start resource information storage unit
223 Content storage unit
231 Resource presentation unit
1101 Remote control
1102 Content start control device
1103 Display
1104 Internet
1211 Portable terminal
1212 Home server
1213 Content start control device
1214 Television
1215 Antenna
1401 Network
1402 Reception unit
1403 License storage unit
1404 DRM client
1405 Decryption unit
1601 LSI

### BEST MODE FOR CARRYING OUT THE INVENTION

The following describes the embodiments of the present invention with reference to the drawings.

### First Embodiment

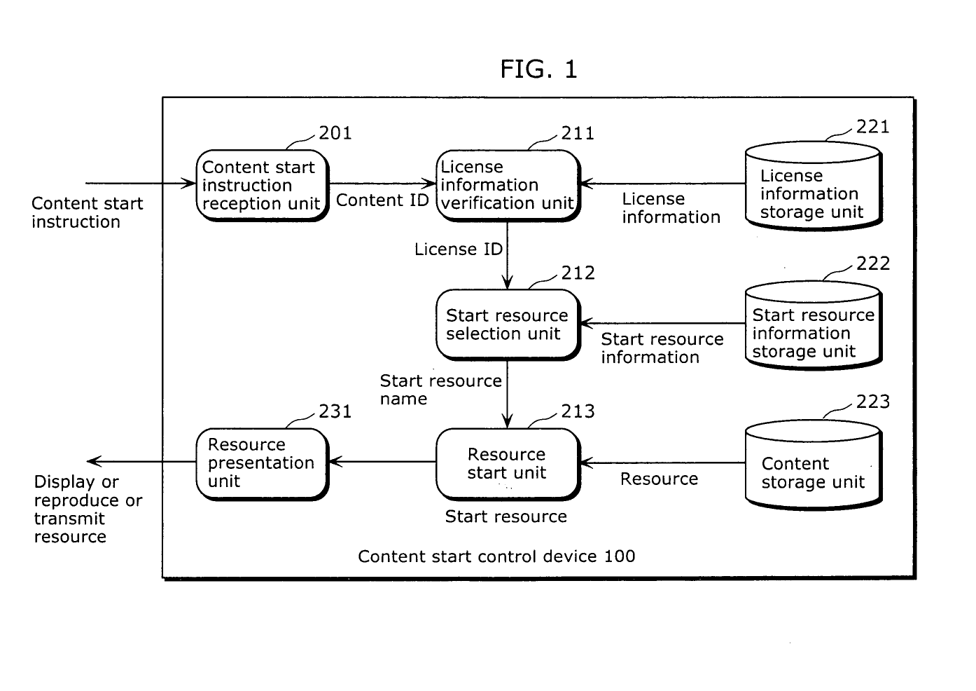

FIG. 1 is a function block diagram of a content start control device 100 according to the first embodiment of the present invention. Moreover, the content start control device 100 according to the first embodiment is characterized in granting plural licenses of different types for one content, verifying license purchase/non-purchase information at the time of content reproduction, and selecting a start resource of the content in accordance with the purchased license.

FIG. 1, a content start instruction reception unit 201 receives a content start instruction specified through the operation of a user, or by an other apparatus. Here, in the case where the content specification method in the content start instruction is not in accordance with a content ID that can identify the content, the content start instruction reception unit 201 acquires the content ID and passes the content ID to a license information verification unit 211. Furthermore, in the case where the content specification method in the content start instruction is in accordance with such a content ID, the start instruction reception unit 201 passes the content ID to the license information verification unit 211.

The license information verification unit 211, retrieves a purchased license associated with the content ID obtained from the content start instruction reception unit 201 from license information stored in a license information storage unit 221, and passes the retrieved license ID to a start resource selection unit 212.

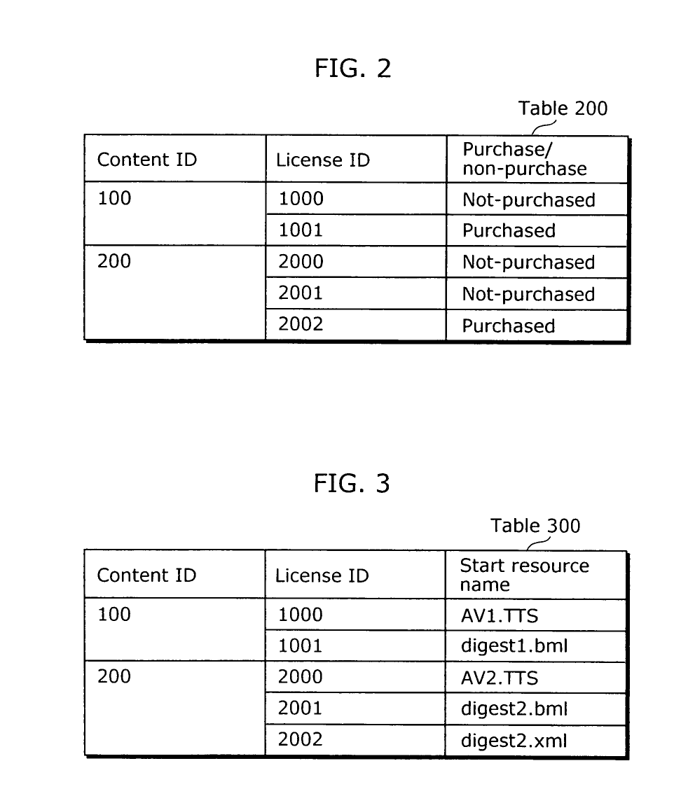

FIG. 2 is a reference diagram showing an example of a table 200 in which the license information stored in the license information storage unit 221 is described.

In the diagram, it is indicated that two licenses, with license ID 1000 and license ID 1001 respectively, exist as licenses associated with the content of a content ID 100; the license with license ID 1000 is “not-purchased” and the license with license ID 1001 is “purchased”.

Furthermore, it is indicated that three licenses, with license ID 2000, license ID 2001, and license ID 2002 respectively, exist as licenses associated with the content of a content ID 200; the licenses with license ID 2000 and license ID 2001 are “not-purchased” and the license having license ID 2002 is “purchased”.

Then, when performing retrieval from the license information in FIG. 2 using the content ID 100, the license information verification unit 211 accesses purchase/non-purchase information of the two licenses associated with the content ID 100, and retrieves, from between the license ID 1000 and license ID 1001, the license ID 1001 which is a purchased license. In such manner, the license information verification unit 211 of the content start control device 100 in the first embodiment can operate and retrieve a purchased license even when the content ID and license ID are in a one-to-many configuration.

The start resource selection unit 212 retrieves, from start resource information stored in a start resource information storage unit 222, a start resource name associated with the content ID and the license ID obtained from the license information verification unit 211.

FIG. 3 is a reference diagram showing an example of a table 300 in which the start resource information stored in the start resource information storage unit 222 is described.

In this table 300, content IDs are stored in the first column, license IDs are stored in the second column, and resource names associated with the first and second columns are stored in the third column. For example, the first row of the table 300 shows that the start resource for content ID 100 and license ID 1000 is “AV1.TTS”. When performing retrieval from the start resource information example in FIG. 3 using the content ID 100 and license ID 1001, the start resource selection unit 212 retrieves a resource name “digest1.bml”. The start resource selection unit 212 passes the retrieved resource name to a resource starting unit 213.

The resource starting unit 213 obtains, from a content storage unit 223, a resource corresponding to the resource name obtained from the start resource selection unit 212.

A resource presentation unit 231 outputs the result of the reproduced resource or the resource to an other software, or a second device connected via the network, or a recording medium. For example, in the case where the resource is “AV1.TTS” which is a video, the user is able to view the moving picture through the output of the reproduced result of “AV1.TTS” onto a display by the resource presentation unit 231. In another example, through the output of “AV1.TTS” to a home server by the resource presentation unit 231, the home server is able to store “AV1.TTS” in a recording medium included in the home server.

Next, the application to an actual service shall be described.

For example, the content with the content ID 100 is configured of a resource 1 which is AV data including commercial messages (CM), a resource 2 which is written in BML or the like, and a resource 3 which is segment metadata written in XML. This segment metadata is assumed to be metadata which allows digest-viewing which reproduces AV data while skipping CMs.

Subsequently, by using the content start control device 100 of the present invention, a user who has purchased the license 1000 for which the resource is CM-inclusive AV data, is able to reproduce CM-inclusive AV data in sequence from the beginning. Furthermore, for a user who has purchased the license 1001, the start resource is the resource 2 written in BML and, when reproducing the resource 2, it becomes possible to perform reproduction of AV data by referring to the resource 1 which is CM-inclusive AV data while skipping the CMs, in accordance with the segment metadata description written in XML of the resource 3.

In this manner, by using the content start control device 100 of the present invention in a content reproduction apparatus such as a television, the user can purchase a license that enables viewing that matches his preference. In addition, by providing price differences according to different license reproduction methods, it also becomes possible for a content business operator to have one content accepted by users having different preferences.

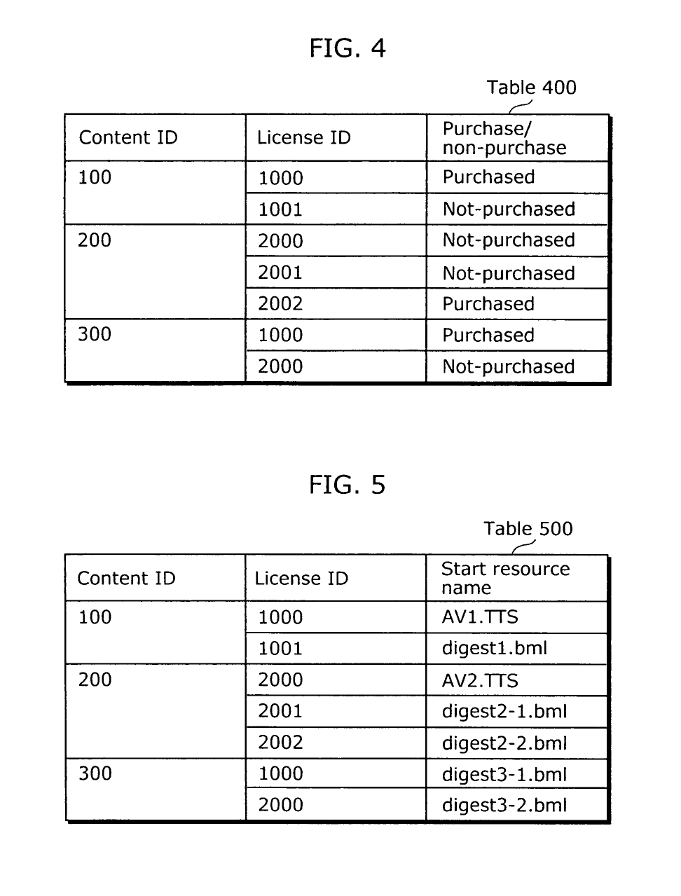

Examples of cases using license information and start resource information that are different from those in FIG. 2 and FIG. 3 are described using the table 400 in FIG. 4, in which license information is described, and table 500 in FIG. 5, in which start resource information is described.

The content of content ID 300 is assumed to be configured of “AV1.TTS” which is CM-inclusive AV data that is the same as with content ID 100, “AV2.TTS” which is CM-inclusive AV data that is the same as with content ID 200, “digest3-1.bml” which enables the reproduction of only the highlight scenes of the main portion of the AV1.TTS, and “digest3-2.bml” which enables the reproduction of only the highlight scenes of the main portion of the AV2.TTS.

FIG. 4 is a reference diagram showing an example of a table 400 in which the license information stored in the license information storage unit 221 is described.

In the information example, it is indicated that two licenses, namely those having license ID 1000 and license ID 1001, exist as licenses associated with the content of the content ID 100; the license having license ID 1000 is “purchased” and the license having license ID 1001 is “not-purchased”.

Since the description for content of content ID 200 is the same as that in FIG. 2, description shall be omitted.

It is indicated that two licenses, namely those having license ID 1000 and license ID 2000, exist as licenses for the content of the content ID 300; the license having license ID 1000 is “not-purchased” and the license having license ID 1000 is “purchased”.

When performing retrieval from the table 400 in FIG. 4, in which license information is described, using the content ID 300, the license information verification unit 211 accesses the purchase/non-purchase information of the two licenses associated with the content ID 300, and retrieves, from between the license ID 1000 and license ID 2000, the license ID 1000 which is a purchased license. Furthermore, when performing retrieval using the content ID 100, the license ID 1000 is retrieved in the same manner as described in FIG. 2. In such manner, the license information verification unit 211 of the content start control device 100 in the first embodiment can operate and retrieve the purchased license even when the content ID and license ID are in a many-to-one configuration. The license information verification unit 211 passes the retrieved license ID to the start resource selection unit 212.

FIG. 5 is a reference diagram showing an example of a table 500 in which the start resource information stored in the start resource information storage unit 222 is described.

The first row of the table 500 shows that the start resource for content ID 100 and license ID 1000 is “AV1.TTS”. The sixth row in this information shows that the start resource for content ID 300 and license ID 1000 is “digest3-1.bml”.

The start resource selection unit 212 obtains license ID from the license information verification unit 211 and, in addition, obtains a content ID from the content start instruction reception unit 201 or the license information verification unit 211. When the start resource selection unit 212 performs retrieval from the table 500 which describes start resource information in FIG. 5, using the content ID 100 and license ID 1000, the resource name “AV1.TTS” is retrieved. Furthermore, when performing retrieval using the content ID 300 and license ID 1000, the license name “digest3-1.bml” is retrieved. The start resource selection unit 212 passes the retrieved resource name to a resource starting unit 213. Moreover, although it is not shown in the present diagram, the same resource can be associated with different license IDs such as assuming “AV1.TTS” as the start resource for the license ID 100, or “AV1.TTS” as the start resource for the license ID 200.

In this manner, with the content start control device 100 according to the first embodiment, reproduction using the same license for plural contents becomes possible by using license information and start resource information in which content IDs and resource names are in a many-to-one configuration. Thus, as a service intended for a user who has already purchased the license ID 1000 for the content of the content ID 100, the content business operator can provide the content of the content ID 300 which enables a new way of viewing AV1.TTS which is already existing AV data.

Note that although resource names are denoted by character strings in the descriptions in the first embodiment, the resource name may be a character string and may also be a numerical value as long as it is information that can identify a resource.

Furthermore, the source from which the license information storage unit 221, the start resource information storage unit 222, and the content storage unit 223 obtain data may be a storage area of the same recording medium or a storage area of a different recording mediums. Furthermore, the respective storage areas may be managed by the same file system or managed by different file systems.

Here, the recording medium may be a recording medium which allows reading and writing and may also be a read-only recording medium, such as a RAM, a ROM, a Flash ROM, an EEPROM, a hard disk, a memory card, an IC card, and an optical disc. Furthermore, it may also be a recording medium that is fixed within the content start control device, a recording medium that can be detached from the content start control device, or a recording medium which exists outside the content start control device and can be read by the content start control device via a network.

Note that it is also possible to have the start resource selection unit 212 obtain a content ID from the license information verification unit 211, or obtain a content ID from the content start instruction receiving unit 201. Furthermore, the resource presentation unit 231 may also be included in the resource starting unit 213.

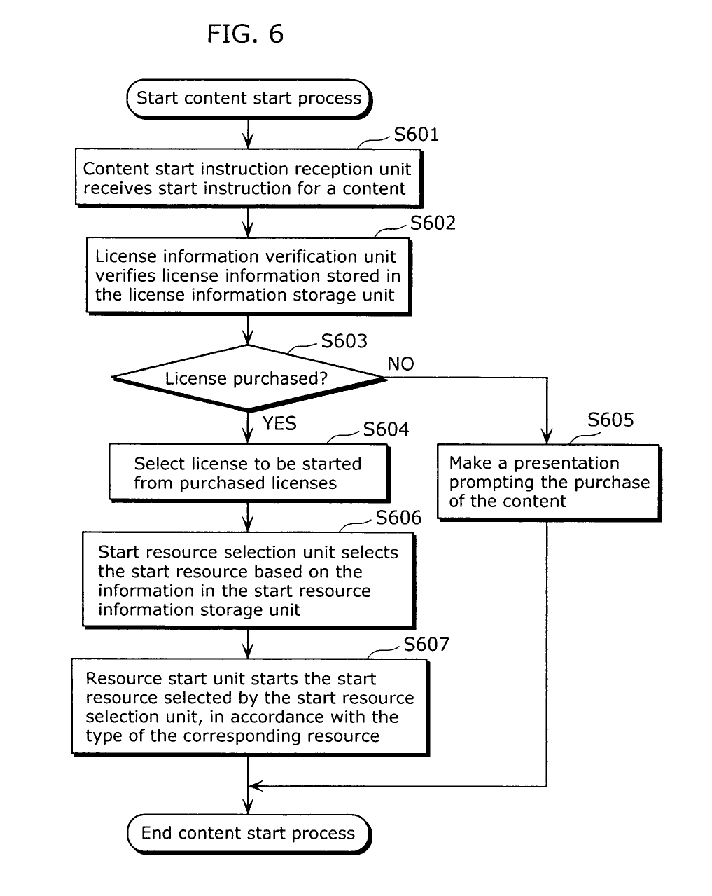

FIG. 6 is a flowchart showing the operational sequence from the start to the end of the content starting process in the content start control device 100 in FIG. 1.

First, the content start instruction unit 201 of the content start control device 100 receives a start instruction for a content (S601).

Next, the license information verification unit 211 receives, from the content start instruction unit 201, the content ID of the content for which the start instruction is received, and obtains the license information recorded in the license information storage unit 221 (S602).

Subsequently, the license information verification unit 211 judges, from the license information, whether or not the license associated with the received content ID has been purchased (S603). In the case where the license has been purchased (YES in S603), the license information verification unit 211 selects the license to be started from among the purchased licenses, using purchased license information (S604).

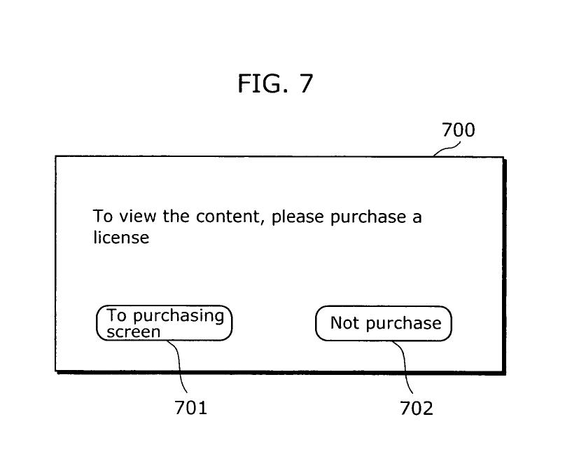

On the other hand, in the case where the license has not been purchased (NO in S603), the resource of the resource name which is preset in the content start control device 100 is started (S605). This resource is data written in a language such as BML, and includes functions for purchasing a license and descriptions for implementing a user interface such as buttons, and is recorded in a part of a storage device which is present in the content start control device 100. By starting this resource, the display which prompts the purchase of the license in FIG. 7 is outputted to the user (S605).

FIG. 7 is a reference diagram of a display screen 700 for prompting the purchase of a license to a user. When the user selects “To purchasing screen (701)” on the screen 700, the purchasing screen is displayed and the user can purchase a license. Furthermore, the user selects “Not purchase (702)” when deciding not to purchase a license.

Next, the start resource selection unit 212 selects, based on the start resource information stored in the start resource information storage unit 222, the start resource associated with the license to be started which was selected in S604 (S606).

Then, the resource starting unit 213 starts the start resource selected by the start resource selection unit 212, using a method which is in accordance with the resource (S607), and the content starting process ends. For example, in the case of a content that can be reproduced like a resource in the MPEG-2 format.

Note that the configuration of the display screen 700 displayed on a window shown in FIG. 7 is but one example, and the form, arrangement, and size of objects such as the display text, buttons, and so on, may be different. In addition, presentation of the window shown in FIG. 7 need not be with BML, and may also be with an application that is built-into the content start control device 100 beforehand.

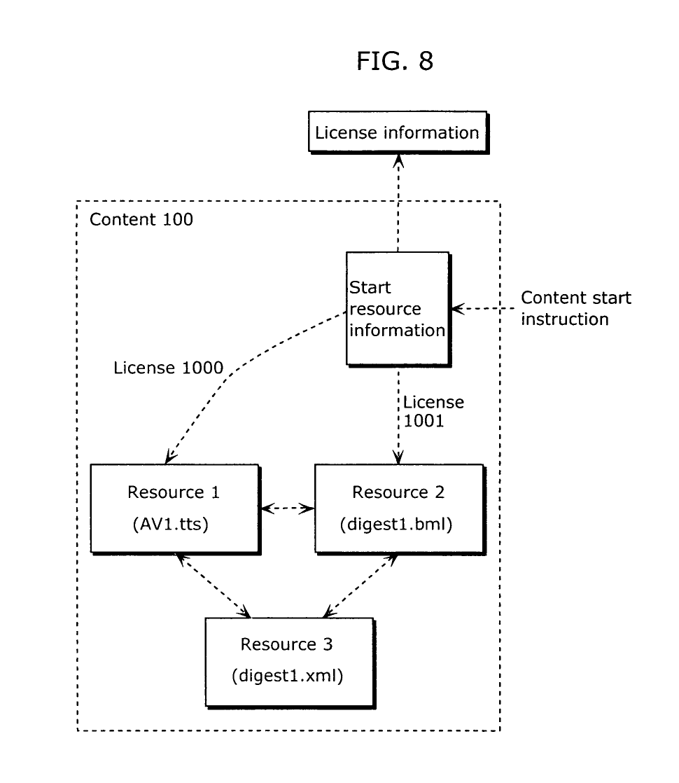

FIG. 8 is a reference diagram of a content reproduced in the content start control device 100 according to the first embodiment.

In the diagram, a content 100 is configured of one start resource information and three resources. Resource 1 is “AV1.tts” which is CM-inclusive AV data; resource 2 is “digest1.bml” which is data written in BML inscriptions and the like, for allowing digest-viewing in which AV data is reproduced while skipping the CMs; and resource 3 is “digest1.xml” which is segment metadata written in XML.

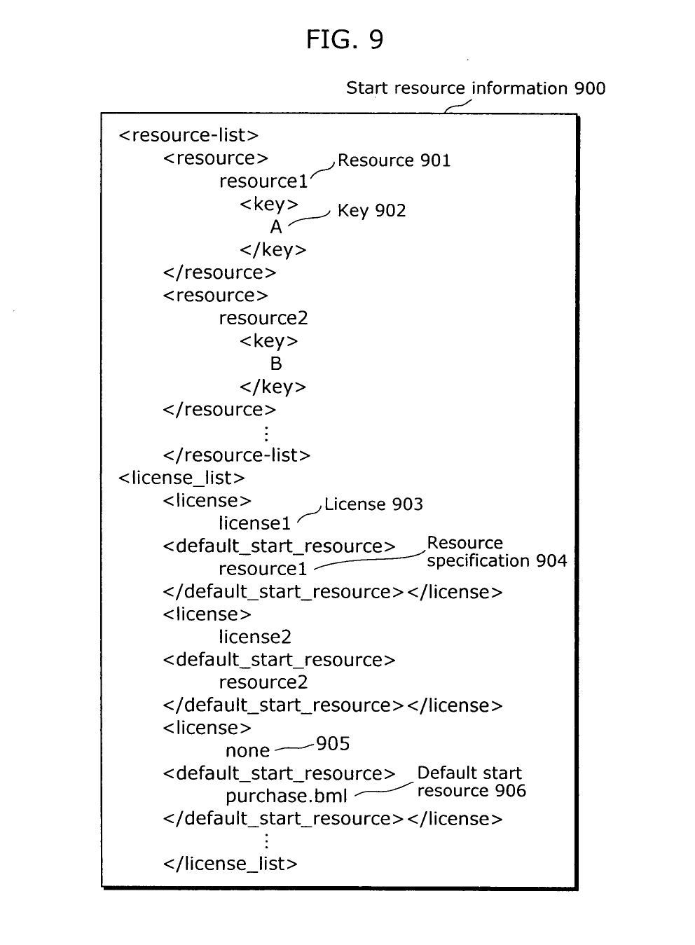

Recorded in the start resource information is DRM information such as the ID, and the like, of a license necessary for reproducing the respective resources. The start resource selection unit 212 selects, as a start resource, a resource which is associated with a license ID that has already been obtained as license information. Further, an example of a description of the start resource information is described in FIG. 9.

In the diagram, when a start instruction for the content 100 is received, the resource 1, which is CM-inclusive AV data to be reproduced normally, is selected in the case where a license 1000 is purchased. In the case where a license 1001 is purchased, the start resource is the resource 2 which is written in BML. When the resource 2 is reproduced, AV data reproduction that refers to the resource 1 which is CM-inclusive AV data and skips CMs is carried out in accordance with the segment metadata described in XML of the resource 3.

FIG. 9 is a reference diagram showing an example of data description of start resource information 900 which is recorded within a content obtained via the network, and referred to during the content start instruction by the content start control device 100 according to the first embodiment.

The start resource information 900 is described by way of an XML statement, for example, and has a resource specification (904) associated with a license (903) described in a row in a license list, and furthermore, a key (902) associated with a resource (901) is described in a row in a resource list. In this manner, with the content start control device 100 according to the first embodiment, resource specification for each of the plural licenses for one content can be carried out by referring to the start resource information 900 during the starting of a content, and reading out from the start resource information 900, a start resource associated with a purchased license ID and starting this resource.

Moreover, in the present diagram, start resource information in which a default start resource name (906) for when there is no license (905) is likewise described in a row in the license list. In this manner, by describing, in the start resource information 900 within the content, the start resource for when there is no license, the default start resource (906) described within the content can be started in the case where there is no corresponding license. Further, it is possible to have, for example, a BML which prompts purchasing, a BML which displays a preview (an AV resource associated with a preview) and so on, as such default start resource (906) and, by specifying such default start resource (906) in the case where a license is not purchased, the range of services provided can be expanded. In addition, at this time, it is also possible to add, as content information, information indicating whether or not a content is one that can be started even without purchasing a license. With this information, the content start control device 100 can also control the display or non-display, to a user, of options for contents to be reproduced. Further still, it can also control the display or non-display of the fact that reproduction is not possible, as additional information for the options.

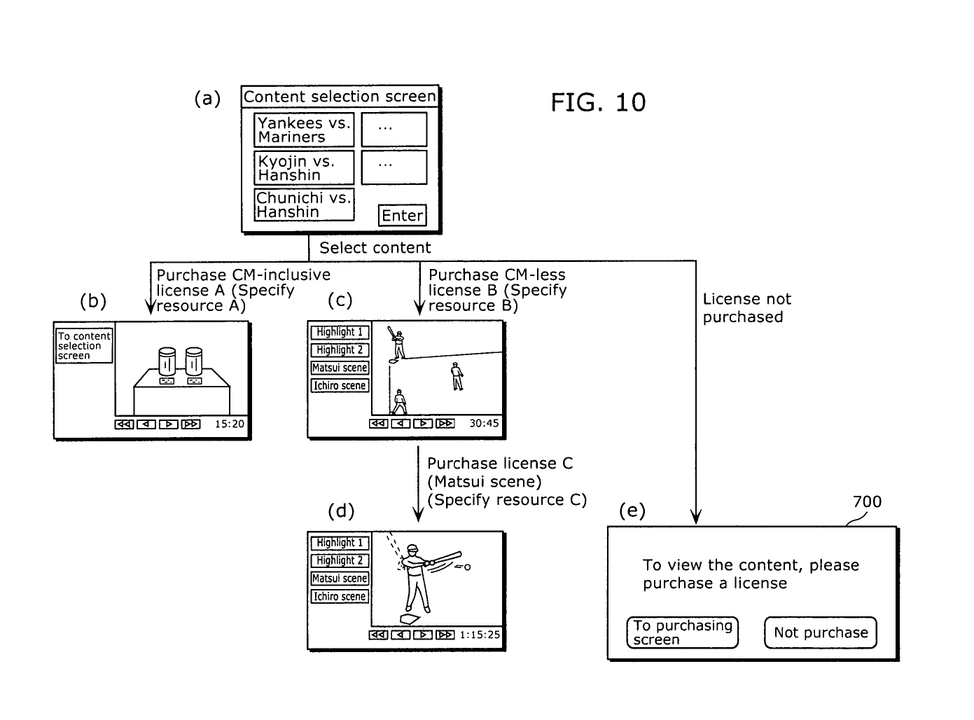

FIG. 10 is a reference diagram showing an example of the transition of screen displays in the content start control device 100 according to the first embodiment.

First, in the case where the user carries out the reproduction of a content, a content list, which describes links to video contents recorded in a server or the like, is displayed in a browser screen as shown in FIG. 10(a).

Next, when the user selects, using a mouse or the like, a desired content to be reproduced, a content reproduction software starts and actual content reproduction is carried out. At this time, in the content start control device 100, the license information verification unit 211 verifies, from the license information storage unit 221, purchased license information from license information associated with the content ID; the start resource selection unit 212 obtains, from the start resource storage unit 222, start resource information of a content associated with a purchased license ID; and the selected resource is started by the resource starting unit 213.

Then, for example, when the user buys a license A, a resource A which is set for the license A is the first to be started as a start resource by the resource starting unit 213, and a CM-inclusive game is reproduced as shown in FIG. 10(b). Furthermore, in the case where a license B is purchased, a resource B which is set for the license B is the first to be started, as a start resource, by the resource starting unit 213, and a CM-less game is reproduced as shown in FIG. 10(c). In addition, in the case where a license associated with a content is not purchased, the content purchase prompt screen 700 in FIG. 7 is displayed as shown in FIG. 10(e).

Then, for example, in the baseball game, selection buttons “Matsui scene”, “Ichiro scene”, and “highlight scene” are displayed depending on the user's license purchase status as shown in FIG. 10(c). By selecting the desired scene to be reproduced from the selection buttons, it is verified, in the content start control device 100, whether or not the license has been purchased and, in the case where the license is purchased, the reproduction of the respective scenes is started, as shown in FIG. 10(d), by selecting and starting the start resource. Note that in FIG. 10(d), in the baseball content, a license C which specifies “Matsui scene” is purchased, and a resource C associated with the license C is started.

In this manner, with the content start control device 100 according to the first embodiment, a plurality of license IDs can be associated with one content ID and, in the case where information on the purchase or non-purchase of the licenses is verified and they are purchased, the resource to be started can be selected for each of the licenses.

Note that with the content start control device 100 according to the first embodiment, in the case where a plurality of licenses is purchased with respect to one content, it becomes possible to display options corresponding to each of the licenses so as to have the user make a selection, or to automatically select a more expensive license and start reproduction, and so on. For example, in the present diagram, it is possible that in the case where the user has already purchased a license for “CM-less” and a license for “Matsui scene”, the start resource associated with the license for the higher-priced “CM-less” is started and reproduction is commenced, or a selection screen for the user to make a selection as to which one to select is displayed.

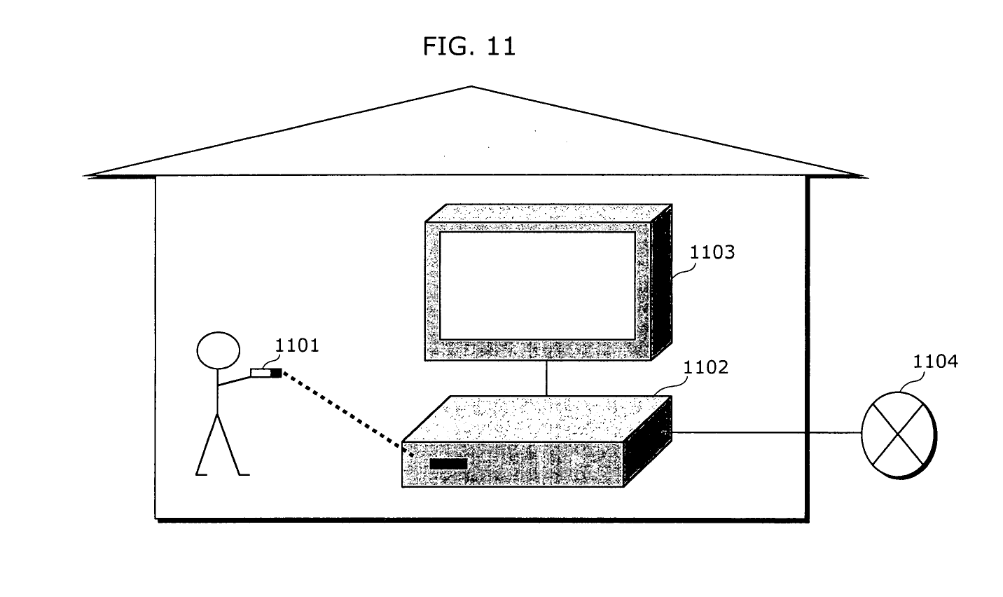

FIG. 11 is a reference diagram showing an example of the connection between a content start control device 1102 in the present invention and other devices.

The content start control device 1102 can receive a signal of a remote control 1101 operated by a user, and the video and audio output of the content start control device 1102 is connected to a display 1103 via a cable that is capable of transmitting video and audio. The display 1103 displays video and audio output from the content start control device 1102. The content start control device 1102 is further connected to an internet 1104, and is capable of obtaining license information, start resource information, a content, and a license from a server via the internet, with the reception of a signal from the operation of the remote control 1101 by the user, or the like, serving as a trigger.

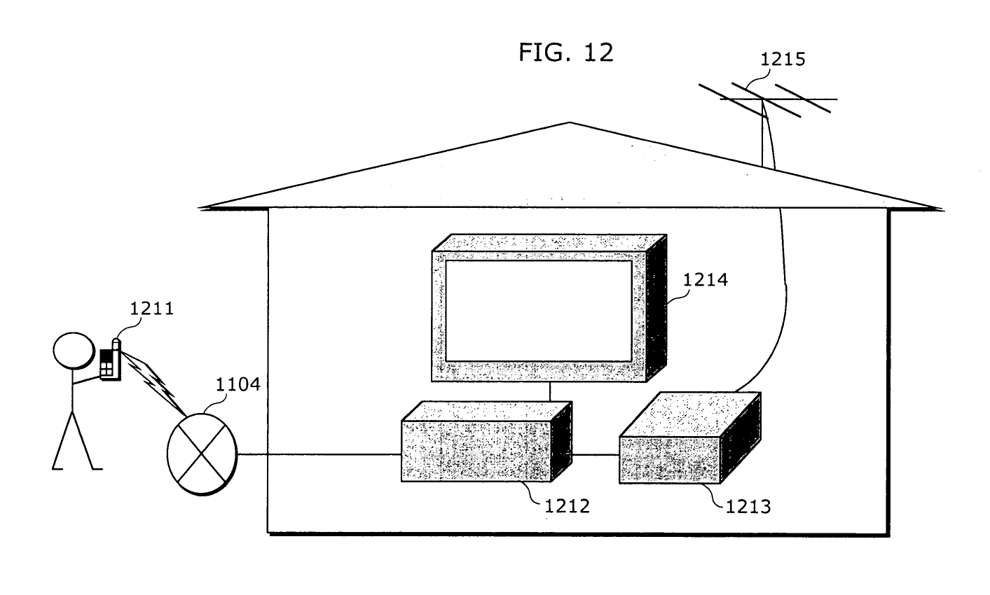

FIG. 12 is a reference diagram showing an example of the connection between a content start control device 1213 in the present invention and other devices.

The user accesses a home server 1212 from a portable terminal 1211 via an intermediary device over the internet. The part of the portable terminal 1211 which connects with the internet may be wire-less or wired. The home server 1212 can receive an instruction in accordance with the access by the user and output a content start instruction to the content start control device 1213. The content start control device 1213 starts the content in the instruction from the home server 1212, and outputs this to the home server. The home server 1212 can store in a storage area of the home server 1212 and/or output to a TV 1214, the output from the content start control device 1213. The content start control device 1213 is connected to an antenna 1215 and can obtain any or all of license information, start resource information, a content, and a license via a broadcast.

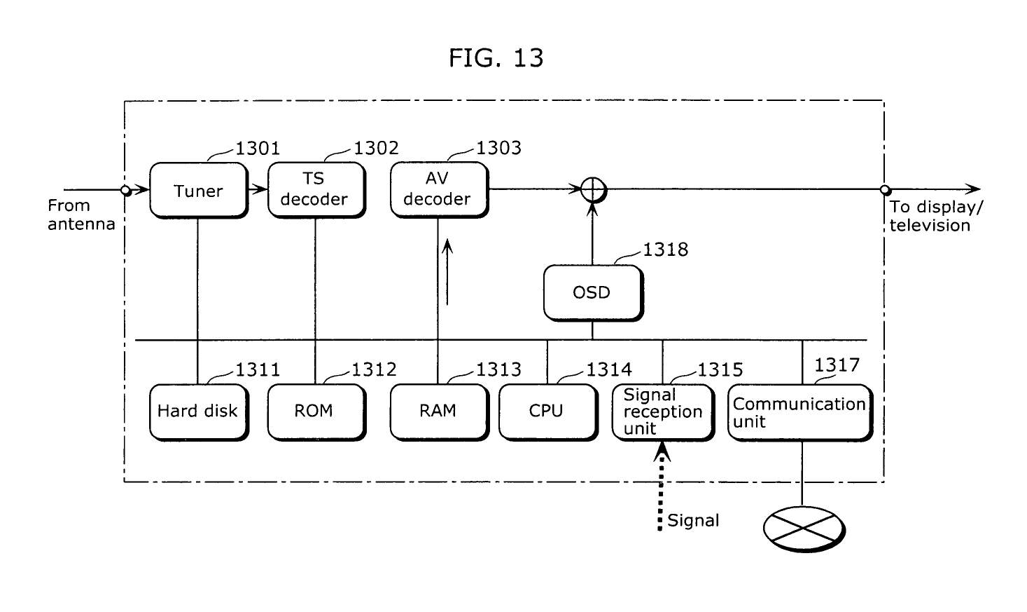

FIG. 13 is a reference diagram showing an example of a hardware configuration for implementing the content start control device of the present invention.

The hardware for implementing the present invention includes a CPU 1314, a RAM 1313, a ROM 1312, a hard disk 1311, a signal reception unit 1315, a communication unit 1317, a tuner 1301, a TS decoder 1302, an AV decoder 1303, and an OSD 1318. Note that the hardware configuration in FIG. 13 is one example, and it is also possible to implement the TS decoder, the AV decoder, and the OSD as software. Furthermore, with the content start control device in the first embodiment of the present invention, it is not necessary to have all the elements of the hardware configuration in FIG. 13.

As described thus far, according to the content start control device 100 according to the first embodiment, by using the plurality of licenses assigned to one content and the start resource information associated with each of the licenses, it becomes possible for the start resource selection unit 212 to select the start resource to be started first as the time of content reproduction in accordance with the type of the license purchased by the user. Accordingly, it is possible for the content provider to provide a plurality of licenses for one content, and easily provide various viewing modes for the same content.

Furthermore, with the content start control device 100 according to the first embodiment, since physically a content is shared with respect to the plurality of viewing modes corresponding to each of the licenses, it is possible to reduce the storage volume of contents to be recorded in the content storage unit 223 compared to the case where one content is assigned to one license.

Furthermore, since the start resource information which is stored in the start resource information storage unit 222, and in which information about licenses and start resources are recorded exist as data which is separate from the resource of a content, the addition of a license can easily be made afterwards without making changes to the original content, by changing the start resource information. As such, the version of a license can be easily upgraded, and it becomes possible to have a service that can easily upgrade a license to allow a plurality of viewing modes, through the user's payment of the price difference between licenses to the content provider.

### Second Embodiment

The following describes the second embodiment of the content start control device according to the present invention.

Note that the content start control device according to the second embodiment is characterized in that the resource included in a content, which is encrypted, is decrypted using a key included in a license during the starting of a start resource.

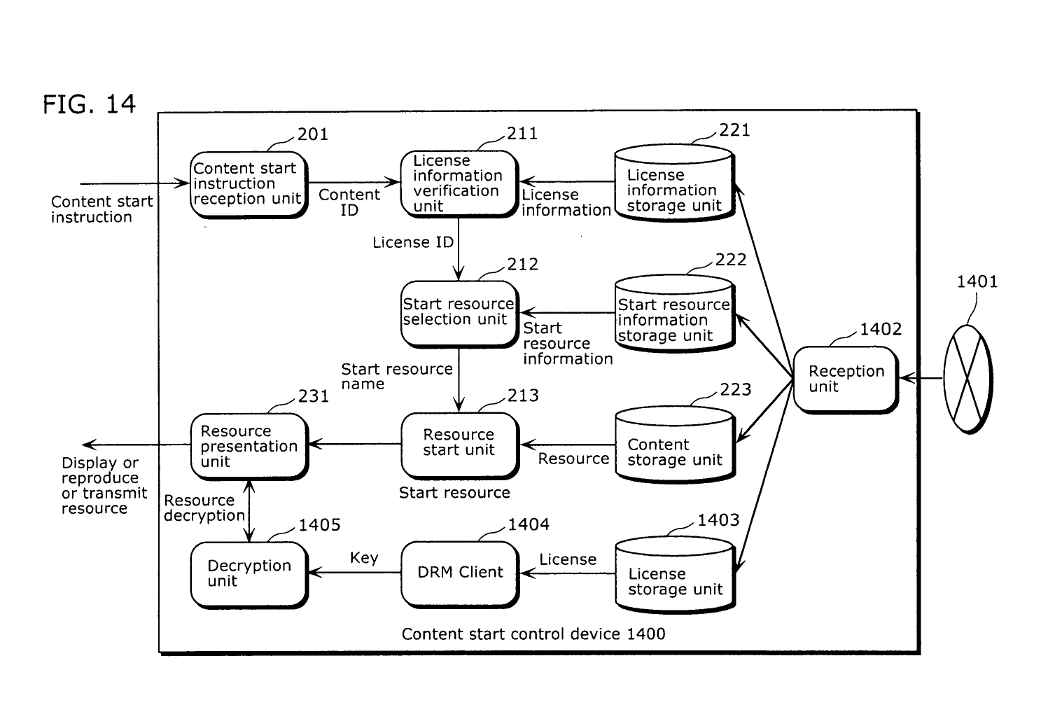

FIG. 14 is a function block diagram for the content start control device 1400 according to the second embodiment of the present invention. Note that in FIG. 14, the same numeric references are used for constituent elements that are the same as in FIG. 14, and their description shall be omitted.

The content start control device 1400 according to the second embodiment includes, in addition to the configuration in the first embodiment described previously, a reception unit 1402, a license storage unit 1403, a DRM client 1404, and a decryption unit 1405.

The reception unit 1402 obtains, from the server, any or all of: information aside from purchase/non-purchase information from among the license information; start resource information; a content; and a license, via a two-way network 1401 such as the Internet, and stores the information aside from purchase/non-purchase information from among the license information in the license information storage unit 221, stores the start resource information in the start resource storage unit 222, stores the content in the content storage unit 223, and passes the license to the license storage unit 1403. Note that the respective storage units write the obtained data onto a storage area. The license information of purchase/non-purchase information is updated at times such as during the purchase of a license by the user, and the expiration of the term of a license.

The DRM client 1404 obtains, from the license storage unit 1403, a license corresponding to the license ID, and sends the key included in the license to the decryption unit 1405.

The decryption unit 1405 obtains the license corresponding to the license ID from the DRM client 1401, and decrypts the encrypted resource using such key. The resource presentation unit 231 reproduces the resource that is decrypted by the decryption unit 1405.

Moreover, the license information storage unit 221, the start resource information storage unit 222, and the content storage unit 223 obtain data may write into a recording area of the same recording medium or a recording area of different recording mediums. Furthermore, the respective recording areas may be managed by the same file system or managed by different file systems.

Here, the recording medium refers to a recording medium that allows writing and/or reading, such as an RAM, a Flash ROM, an EEPROM, a hard disk, a memory card, and an optical disk that can be written into. Furthermore, it may also be a recording medium that is fixed within the content start control device, a recording medium that can be detached from the content start control device, or a recording medium which exists outside the content start control device and can be read by the content start control device.

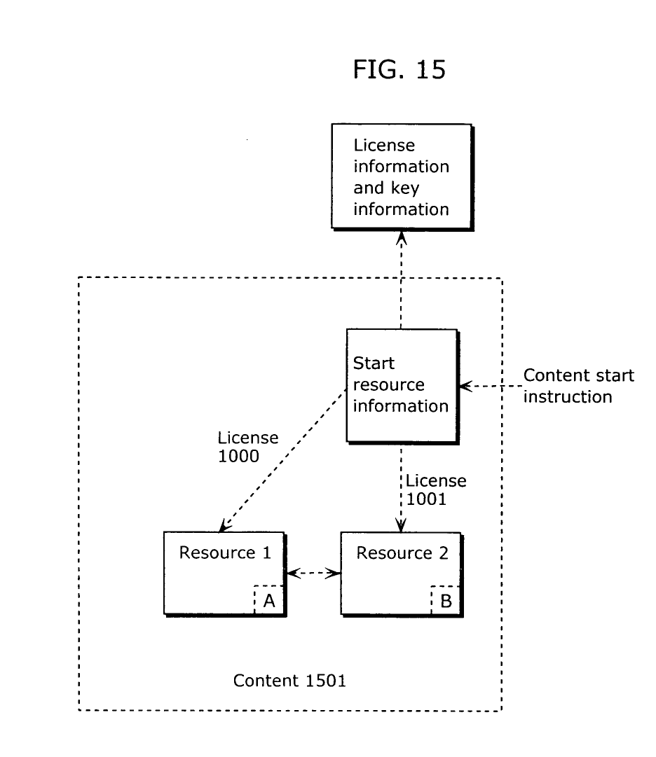

FIG. 15 is a reference diagram showing an example of a content reproduced with the content start control device 1400 according to the second embodiment.

In the diagram, a content 1501 is configured of one start resource information and two resources. A resource 1 is encrypted using a key A, and a resource B is encrypted using a key B.

In the second embodiment, license IDs necessary for reproducing each resource, and DRM information such as key information are recorded in the start resource information recorded within the content 1501, and a resource associated with a license ID that is already obtained as license information is selected as the start resource. Furthermore, the decryption unit 1405 obtains a key recorded in a purchased license when starting a start resource.

Subsequently, in the case where a start instruction for the content 1501 is received and a license 1000 is purchased, the resource 1 is selected and the decryption unit 1405 passes the resource 1 to the resource presentation unit 231 after decryption using the key A recorded in the license 1000. In the case where the license 1001 is purchased, the resource 2 is selected as the start resource, and the decryption unit 1405 passes the resource 2 to the resource presentation unit 231 after decryption using the key B recorded in the license 1001.

As described thus far, with the content start control device 1400 according to the second embodiment, even in the case where the resource to be started first is encrypted, it becomes possible for the decryption unit 1405 to decrypt the resource using a key included in the selected license.

Furthermore, as in the content start control device according to the first embodiment described previously, license information, start resource information, a content, and a license can be deleted and, in addition, it becomes possible to update/add license information, start resource information, a content, and a license via a network.

Next, description is made for the case where license information and start resource information are obtained by the content start control device according to the second embodiment in the case where the network 1401 in FIG. 14 is a broadcast.

The reception unit 1402, as in normal digital broadcast receivers, is configured of a tuner, a transport stream decoder, an AV decoder, and so on. The reception unit 1402 obtains a transport stream via a broadcast, and obtains Program Specification Information (PSI) or a module transmitted through a DSM-CC data carousel within the transport stream, and can also obtain information aside from purchase/non-purchase information from among the license information, and/or start resource information, when these exist within the PSI or the module.

Furthermore, the data of a content can be obtained by the reception by the reception unit 1402 of the module transmitted through the carousel within the transport stream. The broadcast station broadcasts, in the same channel, a content, and license information aside from the purchase/non-purchase information and/or start resource information. By viewing the channel, the content start control device can simultaneously obtain the content and the license information aside from the purchase/non-purchase information and/or start resource information associated with the content.

In addition, the Program Specification Information (PSI) holds the information of plural program streams multiplexed in the transport stream, and is defined in ISO/IEC13818-1. The DSM-CC data carousel is a data transmission method used in digital broadcasting and the like, and is defined in ISO/IEC13818-6.

Note that although, in part of the embodiment described previously, the content start control device obtains license information, start resource information, a content, and a license via a network, the network includes broadcasts through BS, CS, and ground-based broadcast signals, and the like, as well as networks such as CATV, the Internet, local area networks, and so on.

Furthermore, IP Multicast may also be used as the technique used in the transmission and reception of license information, start resource information, a content, and a license. IP Multicast is a technique in which a packet is copied through a device within a network, and distributed to plural devices. Furthermore, it is also possible to obtain the license information, start resource information, content, and license through a combination of the various types of networks. For example, it is also possible to transmit a request for obtaining license information to the server via the Internet, and obtain the license information through a CS broadcast.

In addition, in the respective embodiments described previously, the content start control device may also be packaged as a part of a portable electronic device such as a mobile phone, household AV equipment such as an optical disc player, a peripheral device of household AV equipment such as a remote control, a household game device, a personal computer, a peripheral device for a personal computer such as a printer, and a household electrical appliance such as a microwave oven or refrigerator.

Furthermore, although in the respective embodiments described previously, the respective constituent elements are located within the content start control device, it is also possible that part of the constituent elements are located outside the content start control device with the respective constituent elements being connected via a network. Furthermore, the access from a constituent element to a constituent element may also be carried out via an operating system.

In addition, although in the respective embodiments described previously, constituent elements are divided according to function groupings, it is also possible to have these plural constituent elements integrated into one constituent element having functions which combines the functions of the respective constituent elements. For example, although the content start instruction reception unit 201 and the license information verification unit 222 are represented as separate constituent elements, it is also possible to have one constituent element with the combined functions of a content start instruction reception unit and a license information verification unit, instead of the content start instruction reception unit 201 and the license information verification unit 222.

Note that the network also includes wireless aside from wired cases. “Obtain via the network” includes, not only one-to-one communication, but also one-to-many, and IP Multicast.

Furthermore, a content may be configured of one or a combination of video information such as MPEG-2, and MPEG-4, audio information such as Advanced Audio Coding (AAC), structured markup language data such as HyperText Markup Language (HTML) and Broadcast Markup Language (BML), image information such as Joint Photographic Experts Group (JPEG) and Portable Network Graphics (PNG), Script such as ECMAScript, metadata and so on.

In addition, the respective embodiments described previously are implemented by the interpretation and execution, by the CPU, of predetermined program data stored in a storage device (ROM, RAM, hard disk, and so on) and which enables the execution of the procedures described previously. In this case, the program data may be introduced inside the storage device via a recording medium, and may also be executed directly from a recording medium. Note that the recording medium refers to: a semiconductor memory such as a ROM, a RAM, and a flash memory; a magnetic disc memory such as a flexible disc, and a hard disc; an optical disc such as a CD-ROM, DVD, and a BD; and a recording medium such as a memory card. Furthermore, the recording medium conceptually includes a communication medium such as a telephone line and transportation paths.

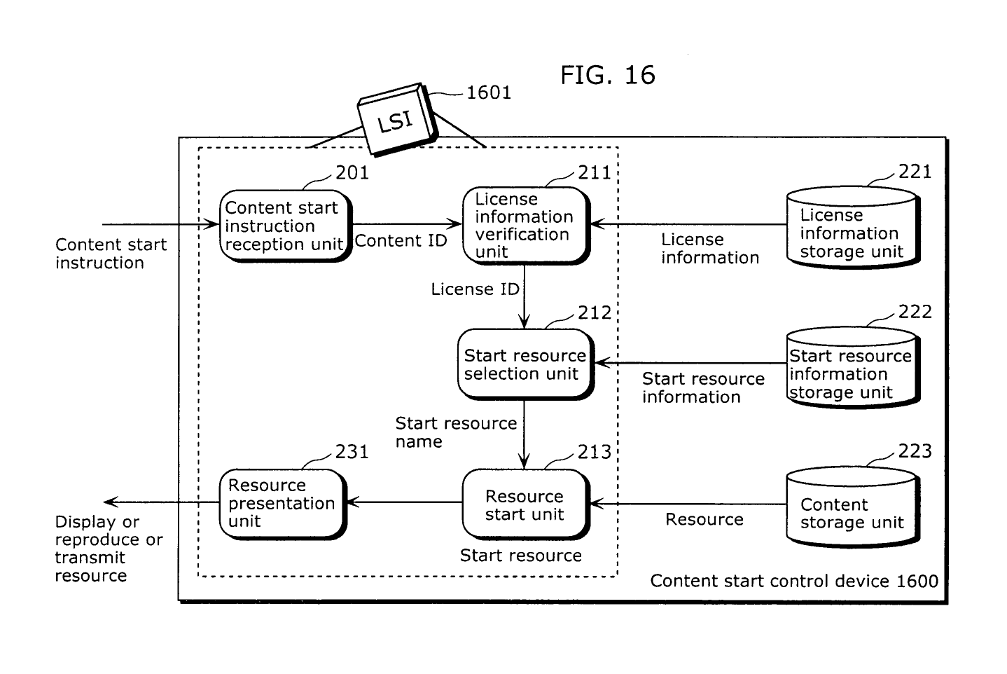

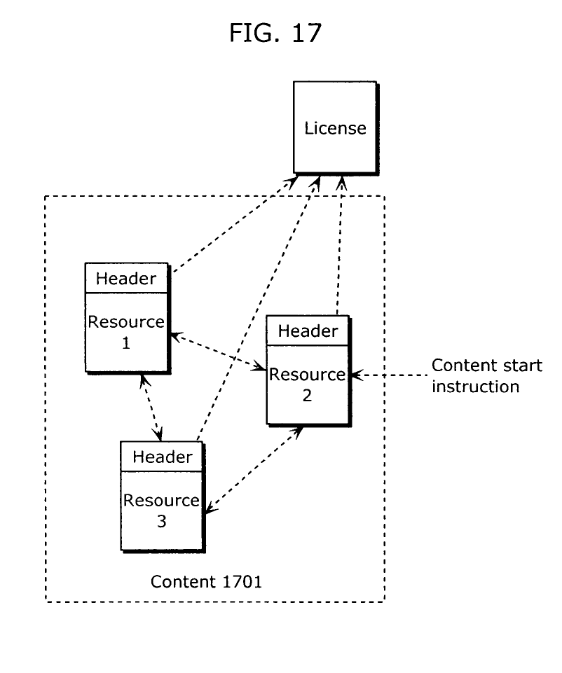

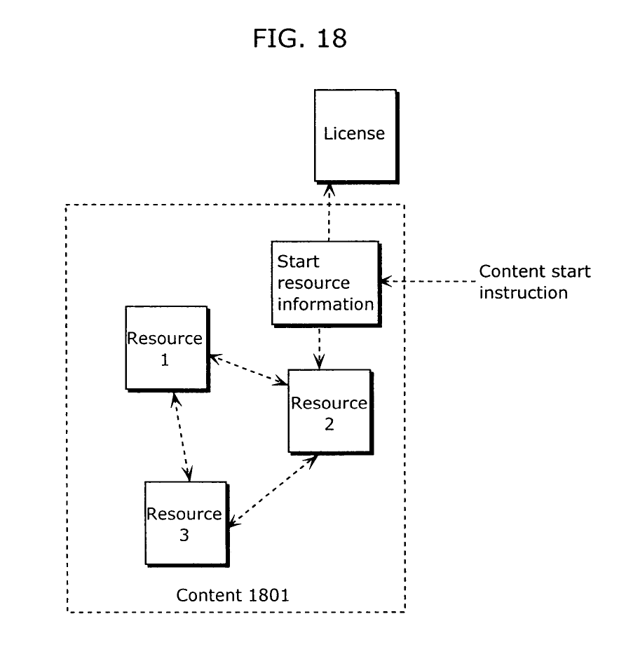

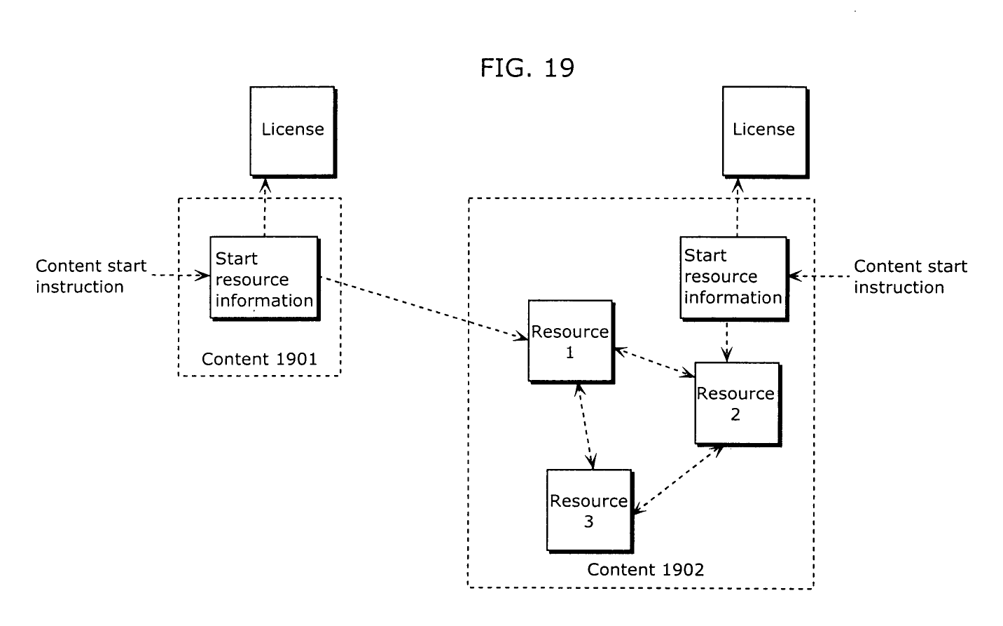

Note that, as shown in FIG. 16, the respective function blocks such as the content start instruction reception unit 201, the license information verification unit 211, the start resource selection unit 212, the resource starting unit 213, the resource presentation unit 231 may also be typically implemented as a an LSI 1601 which is an integrated circuit. They may also be implemented separately as single chips, or as a single chip including a part or all of the function blocks. Although referred to here as the LSI 1601, it may also be called an IC, a system LSI, a super LSI, and an ultra LSI depending on the level of integration.

Furthermore, the method of circuit integration is not limited to the LSI, and implementation with a dedicated circuit or a general purpose processor is also possible. A Field Programmable Gate Array (FPGA) which allows programming after the LSI is manufactured, and a reconfigurable processor that allows the connection and setting of circuit cells within the LSI to be reconfigured may also be used.

In addition, in the case where integrated circuit technology which replacing the LSI appears with the development of semiconductor technology or the offset of separate technology, the integration of the function blocks may also be carried out using such technology. There is also the possibility for the application of biotechnology, and so on.

### INDUSTRIAL APPLICABILITY

The content start control device according to the present invention has a function for starting a content in accordance with a license, and is useful as a function of household AV equipment such as a television, a home server, and a media recorder, for example. Furthermore, application as a function of a portable electronic device, a peripheral device of household AV equipment, a household game device, a personal computer, a peripheral device of a personal computer, and a household electrical appliance is also possible.

1. A content start control device that controls a starting of a content, said content start control device comprising:
a content start instruction reception unit operable to receive a start instruction for a content;
a license information storage unit operable to store license information of the content;
a license information verification unit operable to obtain, based on the license information, a purchased license from among plural licenses which are associated with the content, in the case where the start instruction is received by said content start instruction reception unit;
a start resource information storage unit operable to store start resource information indicating start resources, each of which is associated with one of the licenses;
a start resource selection unit operable to select, based on the start resource information, a start resource that is associated with the license which is verified by said license information verification unit as having been purchased; and
a resource starting unit operable to start the start resource selected by said start resource selection unit.

2. The content start control device according to claim 1,
wherein the license information includes a relationship among a content ID, plural license IDs used for a content which corresponds to the content ID, and purchase/non-purchase information of each of the license IDs,
the start resource information includes a relationship among the content ID, the plural license IDs used for the content which corresponds to the content ID, and respective start resources for the license IDs,
said license information verification unit is operable to obtain, based on the license information, a license ID of the purchased license, from among plural license IDs which are associated with a content ID of the content for which the start instruction is received, and
said start resource selection unit is operable to select a start resource which is associated with the license ID, based on the start resource information.

3. The content start control device according to claim 2,
wherein, in the license information or the start resource information, the license ID and the content ID are in a one-to-many or a many-to-one relationship.

4. The content start control device according to claim 2,
said license information verification unit is operable to obtain the license ID based on a predetermined condition, in the case where there are plural purchased licenses.

5. The content start control device according to claim 1,
wherein said content start instruction reception unit is operable to receive a start instruction for a content, from a second device,
said license information verification unit is operable to obtain, by using the license information, purchase/non-purchase information of a license that is associated with the content for which the start instruction from the second device is received,
said start resource selection unit is operable to select, by using the start resource information, a start resource which is associated with the license in the case where said license information verification unit verifies that the license is purchased, and
said resource starting unit is operable to transmit, to the second device, at least the start resource selected by said start resource selection unit.

6. The content start control device according to claim 5,
wherein said resource starting unit is operable to further transmit, to the second device, the purchased license together with the start resource.

7. The content start control device according to claim 2,
wherein the start resource information further includes key information which is set for each of the start resources, and
said content start control device further comprises:
a license storage unit operable to store the license;
a key extraction unit operable to obtain, from said license storage unit, a part or all of data of the purchased license obtained by said license information verification unit, and extract a key for decrypting the start resource, by using the start resource information; and
a decryption unit operable to decrypt the start resource by using the key extracted by said key extraction unit.

8. The content start control device according to claim 1, further comprising
a display unit operable to display a screen for prompting the purchase of a license in the case where it is verified by said license information verification unit that a license that is associated with the content for which starting is instructed is not purchased.

9. The content start control device according to claim 2,
wherein the start information further includes a default start resource which is started in the case where it is verified by said license information verification unit that all of the plural licenses that are associated with the content for which starting is instructed are not purchased, and
said start resource selection unit is operable to select the default start resource in the case where it is verified by said license information verification unit that all of the plural licenses that are associated with the content for which starting is instructed are not purchased.

10. The content start control device according to claim 9,
wherein the start resource information further includes information on availability of the default start resource, and
said content start control device further comprises
a judgment unit operable to judge that a content including the start resource information can be displayed in a list of reproducible content only when, in the case where the license is not purchased, the default start resource is available based on the information.

11. The content start control device according to claim 1,
wherein said start resource selection unit is operable to select a preset resource in the case where the start resource that is associated with the license ID which is verified by said license information verification unit is not present in the start resource information.

12. The content start control device according to claim 2,
wherein at least one of information aside from the purchase/non-purchase information from among the license information, and the start resource information are described in a content obtained via a network.

13. A content start control method for use in a content start control device that controls a starting of a content, said content start control method comprising:
a content start instruction reception step of receiving a start instruction for a content;
a license information storage step of storing license information of a content;
a license information verification step of obtaining, based on the license information, a purchased license from among plural licenses which are associated with the content, in the case where the start instruction is received in said content start instruction reception step;
a start resource information storage step of storing start resource information indicating start resources, each of which is associated with one of the licenses;
a start resource selection step of selecting, based on the start resource information, a start resource that is associated with the license which is verified in said license information verification step as being purchased; and
a resource starting step of starting the start resource selected in said start resource selection step.

14. The content start control method according to claim 13,
wherein the license information includes a relationship among a content ID, plural license IDs used for a content which corresponds to the content ID, and purchase/non-purchase information of each of the license IDs,
the start resource information includes a relationship among the content ID, the plural license IDs used for the content which corresponds to the content ID, and respective start resources for the license IDs,
in said license information verification step, a license ID of the purchased license is obtained, based on the license information, from among plural license IDs which are associated with a content ID of the content for which the start instruction is received, and
in said start resource selection step, a start resource which is associated with the license ID is selected, based on the start resource information.

15. A program for use in a content start control device that controls a starting of a content, said program comprising:
a content start instruction reception step of receiving a start instruction for a content;
a license information storage step of storing license information of a content;
a license information verification step of obtaining, based on the license information, a purchased license from among plural licenses which are associated with the content, in the case where the start instruction is received in said content start instruction reception step;
a start resource information storage step of storing start resource information indicating start resources, each of which is associated with one of the licenses;
a start resource selection step of selecting, based on the start resource information, a start resource that is associated with the license which is verified in said license information verification step as being purchased; and
a resource starting step of starting the start resource selected in said start resource selection step.

16. The program according to claim 15,
wherein the license information includes a relationship among a content ID, plural license IDs used for a content which corresponds to the content ID, and purchase/non-purchase information of each of the license IDs,
the start resource information includes a relationship among the content ID, the plural license IDs used for the content which corresponds to the content ID, and respective start resources for the license IDs,
in said license information verification step, a license ID of the purchased license is obtained, based on the license information, from among plural license IDs which are associated with a content ID of the content for which the start instruction is received, and
in said start resource selection step, a start resource which is associated with the license ID is selected, based on the start resource information.

17. A recording medium on which the program according to claim 15 is recorded.

18. An integrated circuit for use in a content start control device that controls a starting of a content, said integrated circuit comprising:
a content start instruction reception unit operable to receive a start instruction for a content;
a license information verification unit operable to obtain, based on license information of the content, a purchased license from among plural licenses which are associated with the content, in the case where the start instruction is received by said content start instruction reception unit;
a start resource selection unit operable to select, based on start resource information indicating start resources, each of which is associated with one of the licenses, a start resource that is associated with the license which is verified by said license information verification unit as being purchased; and
a resource starting unit operable to start the start resource selected by said start resource selection unit.

19. A recording medium on which the program according to claim 16 is recorded.
